(19) United States
(12) Patent Application Publication
(10) Pub. No.: US 2007/0070937 A1
(43) Pub. Date: Mar. 29, 2007

(54) Multi-radio mesh network channel selection and load balancing

(76) Inventors: Mustafa Demirhan, Hillsboro, OR (US); Mousumi M. Hazra, Beaverton, OR (US); Jing Z. Zhu, Hillsboro, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/239,541

(22) Filed: Sep. 28, 2005

(51) Int. Cl. H04Q 7/00

(52) U.S. Cl. 370/328

(57) ABSTRACT

A channel list indicates a preference order for multiple channels of a wireless mesh network. A mesh point can configure its wireless communication resources with channel assignments based at least in part on the channel list. The mesh point may assign channels of a preference indicated in the channel list with wireless communication resources of a corresponding preference order.

### FIELD

Embodiments of the invention relate to wireless networks, and more particularly to channel selection and traffic allocation in multi-radio wireless devices.

### BACKGROUND

Parameter configuration change in a wireless mesh network is traditionally difficult and time consuming, which leads to high costs. Traditionally parameter configuration change is performed manually. Among the parameters that can be altered is the wireless communication channel. Mesh points including access points in a mesh network may include multiple wireless communication resources that may each be assigned a channel. The manner of assigning the channels has traditionally been inconsistent across the network, resulting in throughput inefficiencies.

Some traditional approaches for network parameter configuration were performed with centralized configuration management. Centralized configuration management introduces a special management node for every network, which results in a single point of potential failure for the entire network. Also, special hardware and potentially software is needed for the manager.

### BRIEF DESCRIPTION OF THE DRAWINGS

The following description includes discussion of various figures having illustrations given by way of example of implementations of embodiments of the invention. The drawings should be understood by way of example, and not by way of limitation.

FIG. 1 is a block diagram of an embodiment of a mesh network.

FIG. 2 is a block diagram of an embodiment of a mesh point of a mesh network.

FIG. 3 is a block diagram of an embodiment of a multi-radio interface module.

FIG. 4 is a flow diagram of an embodiment of assigning channels to radios in a mesh network.

FIG. 5 is a flow diagram of an embodiment of receiving a packet at a mesh point having multiple radios.

FIG. 6 is a flow diagram of an embodiment of load balancing transmit traffic across multiple radio resources in a mesh point.

### DETAILED DESCRIPTION

As used herein, references to one or more “embodiments” are understood as describing a particular feature, structure, or characteristic included in at least one implementation of the invention. Thus, phrases such as “in one embodiment” or “in an alternate embodiment” appearing herein describe various embodiments and implementations of the invention, and do not necessarily all refer to the same embodiment. However, they are also not necessarily mutually exclusive. Descriptions of certain details and implementations follow, including a description of the figures, which may depict some or all of the embodiments described below, as well as discussing other potential embodiments or implementations of the inventive concepts presented herein. An overview of embodiments of the invention is provided below, followed by a more detailed description with reference to the drawings.

In wireless mesh networks (including extended service set (ESS) mesh networks) having mesh points with multiple radios, one or more mesh points can be configured to perform distributed channel selection and load balancing. Wireless mesh networks are described in the Institute of Electrical & Electronics Engineers (IEEE) 802.11 TGs Simple Efficient Extensible Mesh (SEE-Mesh) Proposal, published June 2005, often to referred to as “the 802.11s standard.” A wireless mesh is a wireless local area network (WLAN) including two or more mesh points interconnected or communicatively coupled via wireless links, and supporting mesh services. Mesh services are services provided by the WLAN mesh, or simply the “mesh network,” that support the control, management, and/or operation of the mesh network. A mesh point is any device or entity that includes an interface to the wireless medium of the wireless network, and may be an access point and/or a client. The wireless medium and associated links are compliant with one or more IEEE 802.11 standards for Wireless Local Area Networks (WLANs), including for example, .11a, .11b, .11g, and existing or future variations. Furthermore, in one embodiment, the teachings herein may have some applicability to one or more IEEE 802.16 standards for wireless metropolitan area networks (MANs). Distributed channel selection can be performed with decentralized monitoring of the wireless communication environment and distributed initiation of channel selection. Additionally, for devices that include multiple radios, there may be load balancing across the different radios. As used herein, radio refers to any wireless communication device, circuit, and/or other resource.

In one embodiment radio refers to a network interface or network interface card (NIC) having a wireless communication circuit/interface. Wireless communication device, circuit, and/or resource refers to one or more components and possibly associated software to enable a computing device or other entity to interface with the wireless network (e.g., transmitting/receiving communications over the network). Although the term “radio” is used herein for purposes of ease in description, the term is not limiting, and refers herein to any wireless communication interface. The mesh point can include any computing device, access point, or other wireless-communication enabled device that may interface with the wireless network.

A mesh network can allow devices to operate in a multi hop manner to extend wireless range and provide robust connectivity. Devices in a mesh network can be equipped with one or more NICs or other radios. When mesh points include multiple radios, each radio may operate on a different channel. The channels can be selected to enable all devices in the network to communicate with all other devices of the same network, which can improve the overall achievable network throughput.

To coordinate the use of communication channels across the network, a device in the mesh network coordinates with other device in the network to select a priority of wireless communication channels, or simply wireless channels. The wireless channels may be scanned and observed for communication link quality among the various mesh points (e.g., the sum quality of the channel as observed collectively between each pair of mesh points). With information gathered from around the network, a leader can select which is a best channel, and which is a next-best channel, and so forth. The channels can be organized in a channel priority list, or simply channel list, to indicate a priority of the wireless channels. The priority may generally correspond to the overall quality of the channel among the various links on the network. In one embodiment the generation of the channel list with the channel priorities is performed periodically to adjust to a changing communication environment. The periodicity can be established based on an amount of time, the occurrence of a network event, a number of packets, a number of connection established, etc.

The radios may also have a priority order. The priority order of the radios can be set in hardware or software, and indicates which radio is a “first” communication resource, which is a “second” communication resource, and so forth. The device will execute software referring to the first and second radios according to whatever priority is indicated for a particular hardware resource. Thus, both the wireless channels and the radios may be ordered according to a priority, with a first, second, and so forth of priority.

The leader distributes, or causes another node to distribute, the channel list to indicate the priority order of the channels to the mesh points. Each mesh point can then assign the channels in order to the various radios. For example, a mesh point may be configured to assign the channel of priority one with radio one, the channel of priority two with channel two, and so forth. In one embodiment a device will include only a single radio, and so will assign that radio to the channel of priority one. Such uniformity of channel assignment allows for ease of set-up and implementation; however, it may create inefficiencies in throughput. In one embodiment these inefficiencies are overcome by load-balancing scheme for distributing its traffic among multiple wireless links in order to increase throughput. The channel assignment and traffic distribution allows for a dynamic configuring of the network to adapt the network for maximized throughput in both the changing wireless environment and the changing traffic delivered through the network.

The description above assumes the use of a single frequency band within the network. However, with multiple radios, a mesh network may include radios belonging to different frequency bands (e.g., 2.4 GHz frequency band for 802.11b/g and 5 GHz frequency band for 802.11a). If multiple frequency bands are used, the generation and distribution of a channel list may be rendered twice, once for each frequency band.

A channel list as used herein refers to a list of channels available for assignment to a radio for communication within the network. The network will have a finite number of channels available. The list may have a maximum number of entries corresponding to the finite number of channels available. If the maximum number of entries is represented by N, the channel list with N elements may be represented by CL=[cl₁, cl₂, cl₃, . . . , cl_{N}]. In one embodiment the entire network shares a single channel list, which is used by each mesh point to set the channels of its wireless NICs. To provide more detail regarding the example given above, channel assignments can be made as follows: first, the device sets the operating channel of the first radio to cl₁, next, the device sets the operating channel of the second radio (if available) to cl₂, and so forth, setting each radio, n, to a corresponding wireless channel, clₙ, as indicated on the channel list.

Throughout the network, radios will operate on the same wireless channel. The radios that operate on the same wireless channel may be referred to as a NIC set. For example, all radios operating on cl₁ form a NIC set, all radios operating on cl₂ form another NIC set, and so forth. Note that if a device only includes a single radio, it will operate on channel cl, the common operating channel for the network, which means that all mesh points can listen on cl₁. Also note that some devices will not use other channels such as cl₂ and cl₃, depending on a number of radios available between a link.

The decentralized monitoring of the wireless environment, generation of the channel list, and distributed initiation of channel changes for NIC sets is dynamic. Examples of methods for performing these functions are described in patent application Ser. No. 10/890,950, entitled “SYSTEMS AND METHODS OF DISTRIBUTED SELF-CONFIGURATION FOR EXTENDED SERVICE SET MESH NETWORKS.” The distributed method allows for the automatic configuring of parameters (focusing on channel configuration) in a wireless ESS Mesh network by using an elected leader to make and disseminate configuration choices for the network.

The algorithm described includes five parts: channel scanning, interference detection, leader election, information gathering, and dissemination of the selected configuration. Channel scanning refers to the scanning or testing of channels performed periodically by mesh points to maintain up-to-date channel interference information. Interference detection refers to the devices participating in detecting interference in the current operating channel. If a device detects significant interference, it may initiate the channel selection process. Leader election refers herein to a process by which a mesh point becomes the leader or master for a transaction (e.g., the channel selection and distribution). In one embodiment the mesh point to initiate the channel selection process is selected to be the leader. Information gathering refers to the collecting, compiling, and analyzing of information obtained through channel scanning and interference detection. The leader receives the information from the other mesh points and processes the information. Dissemination of the selected configuration refers to the leader selecting the best channel, or the channel priority list. In one embodiment the channel priority list is disseminated or distributed throughout the network only if the current channel priority configuration in operation in the network is different than the channel priority determined by the leader. Disseminating the channel list may cause or result in each mesh point configuring its individual radios according to the information in the channel list. Alternatively the leader may include a message or command to cause the mesh point to configure its radios according to the information in the channel list.

The algorithm may be extended to perform selection of the channel list for a multi-radio mesh network. Each interface of each device may perform interference detection, which may indicate interference on any one or more of the radios of a particular mesh point. A mesh point can initiate leader election for a channel list change transaction if excessive interference is detected on any of its operational channels. After the leader is elected and it gathers information from the other mesh points, the leader can use the gathered information to select N best channels for the entire network. If the new channel list is not the same as the current channel list being used in the mesh, the new channel list will be disseminated throughout the network.

In order to be able to disseminate the messages in a heterogeneous ESS mesh where different devices may have different numbers of NICs, the dissemination of the configuration changes should be performed using a common channel, which should be NIC₁, using cl₁. Alternatively, the information could be disseminated over multiple channels using multiple different radios, or indicating to each mesh point to disseminate the information on all channels, however, this is less efficient use of network resources.

In one embodiment each node or mesh point keeps a neighbor list, including information to indicate the number of radios present on each of its neighbors. The information about the number of radios in each neighbor can, for example, be collected during channel scanning step. Thus, if node A with two NICs has two neighbors B and C with three NICs and one NIC, respectively, node A may have a neighbor list as follows:

TABLE 1
The neighbor list of Node A

Neighbor

| | B | C |
|---|---|---|
| Number of | 3 | 1 |
| NICs | | |

The total number of NICs available for a wireless link from one mesh point to another is determined by the number of NICs of a neighbor that will be the peer on the wireless link. In the above example, link A-B can use two NICs (limited by the two NICs of node A), while link A-C can use only one NIC (limited by the one NIC of node C).

With all NICs of corresponding priority (e.g., NIC sets as described above) in the mesh network operating on the same channel, the channel assignment is relatively simple. However, potential throughput inefficiencies may be generated. Load balancing across multiple NICs within the same mesh point can reduce the inefficiencies. In one embodiment after channel allocations are performed for each NIC as described above, each mesh point distributes its traffic across multiple NICs to achieve load balancing. The load balancing can improve the throughput of the network as a whole. In one embodiment load balancing is performed on a packet-by-packet basis, which is typically more efficient when compared to connection or link based load balancing methods. For each packet received from upper layers (i.e., transmit or egress traffic), the load balancing algorithm can determine how many common channels the device has with the destination of the packet. Determining the number of common channels may be performed based on the information stored in the mesh point about its neighbors and/or the network topology. If the number of common channels is only one (i.e. cl₁), the common channel is used to send the packet out. If multiple channels are possibilities, the mesh point determines which of the possible radios identified will be used. In one embodiment the radio with the smallest transmit or egress queue is selected, and the packet is sent to the selected radio for transmission to its destination. Other metrics can be used to select a radio, for example, lowest percentage of queue use, strongest signal quality, etc. However, queue size captures the effects of both channel quality and channel load. For example, a heavily loaded channel will be expected to have a larger number of queued packets than a lightly loaded channel.

The introduction of load balancing into the mesh network may also introduce the need for re-ordering of the packets at the receiver. The functions of load balancing and packet reordering can be performed by a radio interface module, as described in more detail below. The packets may be received out of order, and could therefore be queued for re-ordering prior to sending the packets to the upper layers. In one embodiment the radio interface module also includes a timer to be set for each packet waiting for reordering. In some cases packets may be lost, which could result in queuing a packet for an indefinite amount of time. With a timer, the packets may be removed from the queue within a pre-set period of time. Thus, when the timer expires, the packet will be released to upper layer, even if there are still some prior packets not received.

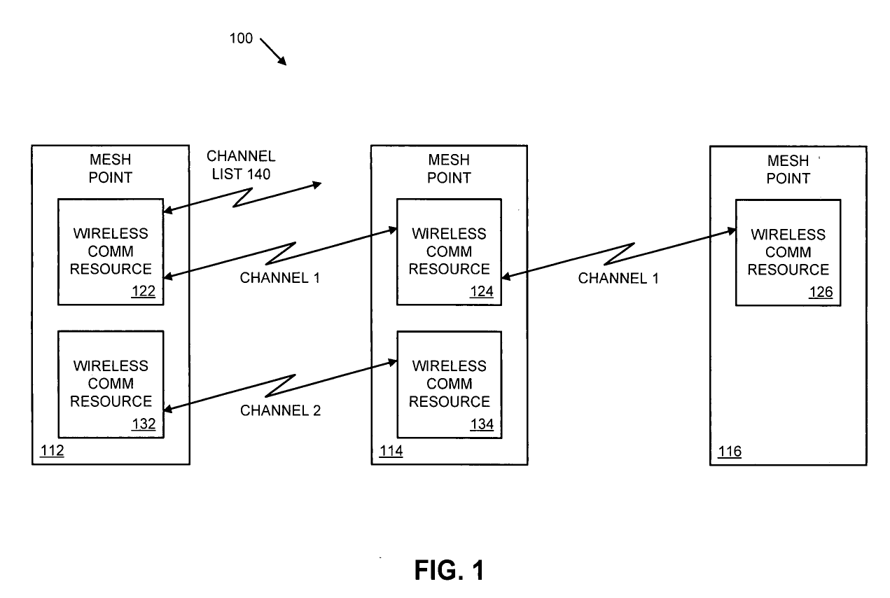

FIG. 1 is a block diagram of an embodiment of a mesh network. Mesh network 100 includes multiple mesh points, 112-116. Each mesh point may be an access point or a client device, and may include a wireless router, a computing device, a laptop computer, a handheld computer, etc. Typical communication through network 100 occurs in a hopping fashion, for example, mesh point 112 communicating a message to mesh point 114, which may in turn transmit the message to mesh point 116, and so forth towards the destination of the message. At the point where the message destination is found, the hopping transmission sequence of the message will terminate.

Mesh points 112 and 114 are shown each having two wireless communication resources 122 and 132, and 124 and 134, respectively. Mesh point 116 is shown having one wireless communication resource 126. Each mesh point of network 100 may have one or more wireless communication resources. Mesh point 112 is shown transmitting channel list 140. The message containing channel list 140 may indicate a channel priority list for use in the network. In one embodiment mesh point 112 is the leader node that generates channel list 140 based on information gathered from the other mesh points, for example, mesh points 114-116. In another embodiment mesh point 112 is simply forwarding the message containing channel list 140.

Upon receiving channel list 140, each mesh point 112-116 configures its wireless communication resources in accordance with channel list 140. Each wireless communication resource 122 and 132 of mesh point 112 can be considered to have a priority, or an order of preference. Wireless communication resource 122 represents a first priority resource, and wireless communication resource 132 represents a next priority resource. Mesh point 112 may include more wireless communication resources that are not shown. Mesh point 112 can configure wireless communication resources 122 and 132 in accordance with the priority order of channels in channel list 140. Thus, wireless communication resource 122 is assigned channelcl₁, which represents the channel of highest preference or priority on channel list 140, and wireless communication resource 132 is assigned channel Cl₂, which represents the channel of channel list 140 of next highest preference or priority. Mesh point 112 would continue for all wireless communication resources it has. Mesh points 114 and 116 can similarly assign their respective wireless communication resources according to channel list 140. In this manner, wireless communication resources 122-126 may be considered a NIC set as defined above, because each wireless communication resource communicates on channel cl₁. Similarly, wireless communication resources 132-134 are included within the same channel set.

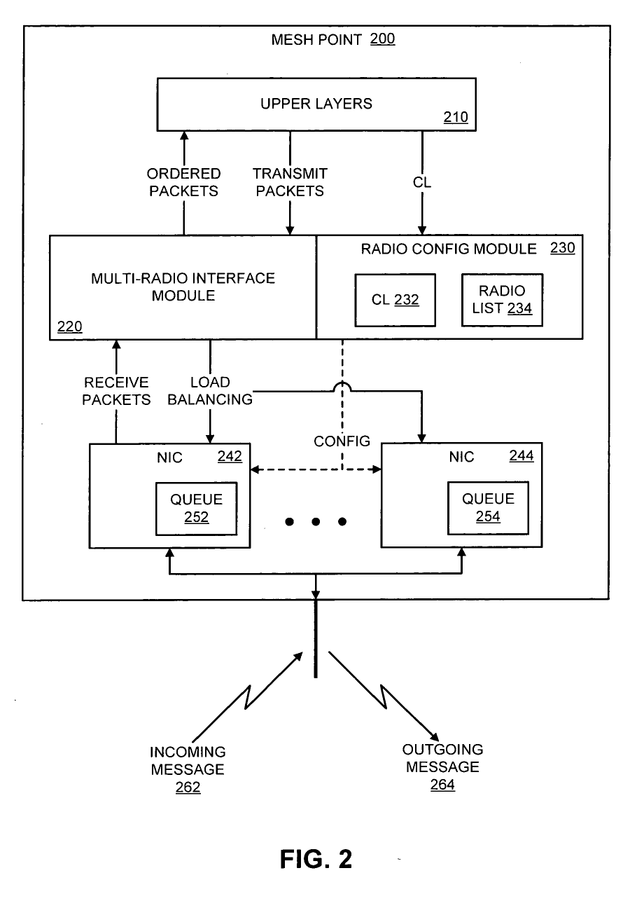

FIG. 2 is a block diagram of an embodiment of a mesh point of a mesh network. Mesh point 200 represents an electronic or computing system, and may illustrate one example of a mesh point according to any mesh point of FIG. 1, or any mesh point as previously described. In one example, mesh point 200 can be a mobile computing device or mobile computing platform, such as a laptop computer, handheld computing system, personal digital assistant (PDA), smart phone, etc., or a fixed-point access point, such as a wireless router or hub.

Mesh point 200 includes one or more antenna elements 202. Antenna 202 may be compliant with an IEEE 802.11 standard, or a different standard. Although IEEE 802.11 is referred to herein, it will be understood that other types of wireless network are possible, and the reference to IEEE 802.11 will not be understood as limiting. Antenna 202 being complaint with the standard refers to having the characteristics for transmission of signals of a compliant frequency range with compliant directivity specifications, and/or other specifications for use of the antenna with IEEE 802.11 or compliant networks.

Mesh point 200 includes upper layer(s) 210, which represent the higher layers of a computing platform. The lower layers typically interact with the hardware peripherals, for example, NICs 242-244. Upper layers 210 may include one or more of, for example, an Internet protocol (IP) layer, application software, an operating system, etc.

Mesh point 200 also includes one or more modules, or a module with one or more purposes or functions or capabilities. Mesh point 200 is shown in one embodiment with multi-radio interface module 220 and radio configuration module 230, which may be separate modules or sub-elements of a single module. Multi-radio interface module 220 enables mesh point 200 to interact with multiple radios as discussed herein, to provide any of channel assignment, load balancing, and/or packet reordering features.

Radio configuration module 230 enables upper layers 210 of mesh point 200 and/or multi-radio interface module 220 to provide configuration information and/or implement configuration changes to NICs 242-244. Radio configuration module 230 may include channel list (CL) 232 and/or radio list 234. Channel list 232 represents a channel list or a channel priority or preference list or table as previously discussed. Radio list 234 represents a list or table indicating the priority or preference order of NICs 242-244. In one embodiment radio configuration module 230 represents one or more mechanisms (e.g., hardware, drivers, firmware, etc., or functions thereof) to enable NICs 242-244 to implement the configuration assignments of the network, and assign a particular radio to a particular channel based on channel list 232.

NICs 242-244 represent example implementations of wireless network interface cards, or other radios or wireless communication resources. NICs 242-244 include the hardware to interface with the wireless medium on the particular channels selected. NICs 242-244 are shown having queues 252-254, which represent transmit and/or receive queues. Queues 252-254 allow for temporary storage of packets that are waiting for the availability of resources to forward the packet to its next location. For example, an outbound packet in a transmit queue may be awaiting the transmission of other packets prior to sending the packet over the wireless network. An inbound packet in a receive queue may be waiting for processing prior to sending the packet to an upper layer.

An example of a case of both receive and transmit follows. Incoming message 262 is received at mesh point 200 at NIC 242. Incoming message 262 may include one or more packets, and one or all packets could be placed in queue 252, which in this case represents a receive queue. Queue 252 as a receive queue may include one or more packets received previously to the arrival of incoming message 262. One or more of the packets may have been received out of order. An out-of-order packet is a packet that has been received prior or later in time as compared to another packet of the same message.

For example, imagine an incoming message A having packets A1, A2, A3, and A4 that represent packets in the order of the message. If the packets were organized as A2, A1, A3, A4, message A might not make sense. Thus, if the packets were received in the order A3, A1, A2, A4, packet A3 would be out of order, and multi-radio interface module 220 could indicate to cache packet A3 until other packet(s) that are temporally ordered prior to packet A3 are received. With the arrival of packet A1, A3 may still remain queued, while packet Al is in order (being the first packet in the message), and so could be sent to upper layers 210 at any time. A2 would be in order as well, and could be sent at any time to upper layers 210. The arrival of packet A2 also satisfies the conditions of having all prior packets with respect to A3 being received, which allows packet A3 to be sent to upper layers 210.

In one embodiment packet A2 is lost in transmission, and does not arrive at NIC 242. Multi-radio interface module 220 may include a timer for each packet placed in queue 252 to indicate a time or a condition after which to send the packet to upper layers 210 out of order. Thus, if packet A2 is not received, A3 may still be sent to upper layers 210 upon the condition of a timer expiring. Other conditions on which A3 could be forwarded to upper layers 210 out of order may include the receipt of an end of message indication for the message associated with packet A3 (message A), the receipt of a certain number of packets, etc. Thus, multi-radio interface module 220 may include packet reordering to order packets prior to sending to upper layers 210. Multi-radio interface module 220 can then send ordered packets to upper layers 210.

In one embodiment incoming message 262 may include or be part of a channel list message from a leader node in the mesh network. The message will be sent to upper layers 210, which may perform one or more operations in response to the message. In one embodiment the channel list is received at and processed by multi-radio interface module 220 and is not sent to upper layers 210. In either case, a radio configuration module 230, which may be part of multi-radio interface module 220 or a separate entity, receives the channel list indicating the order of preference of the channels available for communication in the mesh network. Radio configuration module 230 may store channel list (CL) 232. With information regarding the order of preference of the channels, radio configuration module 230 passes configuration information to NICs 242-244. The configuration information may be CL 232, or it may be a channel assignment for each individual NIC, based on the order of preference of the particular NIC, and CL 232. Thus, a channel list message can be received and cause a configuration in mesh point 200 to assign NICs 242-244 according to the channel list received.

To transmit a message, one or more packets are generated in upper layers 210. The transmit packets may be forwarded to multi-radio interface module 220, which can determine which NIC to use for a given packet. Multi-radio interface module 220 may distribute the packets across multiple NICs instead of sending all packets to the same NIC. By distributing the packets, multi-radio interface module 220 can perform load balancing to improve throughput of packets. In one embodiment multi-radio interface module 220 can control the distribution of packets that are received and routed on the lower layers of an Internet protocol (IP) stack, and thus perform load balancing on packets received by mesh point 200 that are to hop from mesh point 200 to an ultimate destination at another mesh point.

In one embodiment queues 252-254 represent transmit queues, holding packets in queue for transmission out the communication medium interface hardware. In one embodiment multi-radio interface module 220 distributes transmit packets among multiple NICs 242-244 based on the load on the NICs, which may be determined by a size of queues 252-254. A queue that is less full than another may be preferred for a particular packet. Thus, packets may be distributed across NICs that will allow transmission of packets in parallel, or in a substantially simultaneous manner from multiple resources operating independently. Distribution of packet across NICs 242-244 may require a determination of what NICs mesh point 200 has in common with a neighbor that will be a next hop toward the ultimate destination of the packets. Multiple neighbors may be considered for hopping toward the packet destination, and multiple NICs may be common between mesh point 200 and any of the neighbors. Thus, multi-radio interface module 200 may determine a destination of the packet, identify a number of neighbors with connections to the destination or with connections to neighbors along the path of the destination, determine how many links are common to any selected neighbor, and then determine a traffic load profile for the selected links. Thus, NICs may be selected that are associated with links with paths to the packet destination. The traffic load profile may include an amount of queued traffic, a percentage of fill of a queue (if queues are of different maximum capacity in the different NICs), a link with a shortest path to the destination, etc. When a load profile is found that matches what is desired by multi-radio interface module 220, the packets will be forwarded to the selected NIC. As a simple example, multi-radio interface module 220 may seek for a NIC having a least-filled transmit queue that has a link to a neighbor on the path of the packet destination, and when the NIC is discovered, the packet is queued in for the discovered NIC. This process may continue for each transmit packet of a message. Outgoing message 264 represents one or more packets transmitted from a particular NIC, or it could also represent the message that is the sent with multiple packet transfers from multiple NICs.

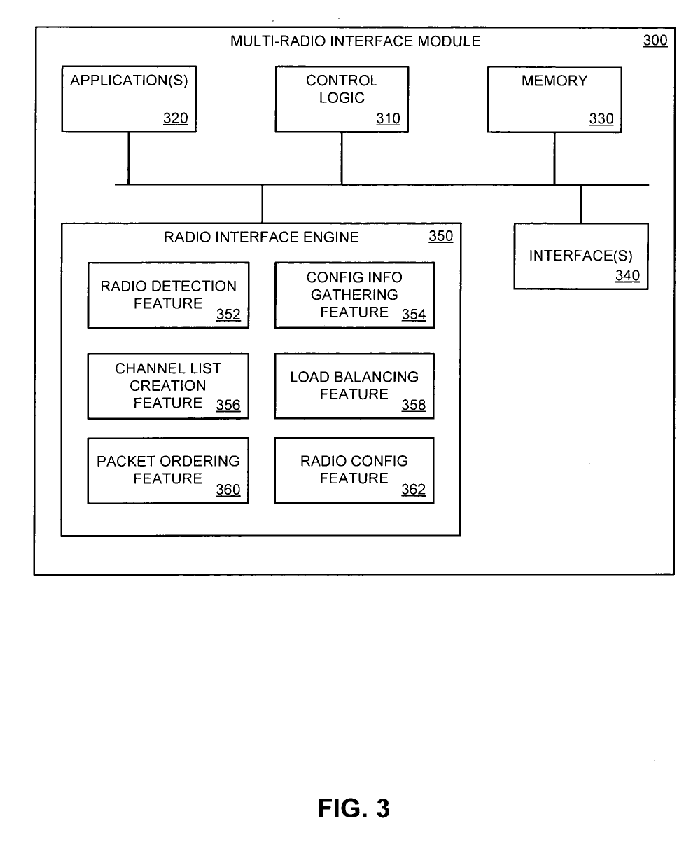

FIG. 3 is a block diagram of an embodiment of a multi-radio interface module. Module 300 includes control logic 310, which implements logical functional control to direct operation of module 300, and/or hardware associated with directing operation of module 300. Control logic can be implemented as hardware, software, firmware, or some combination. In one embodiment module 300 includes one or more applications 320, which represent code sequence and/or programs that provide instructions to control logic 310 and/or operate on top of (e.g., are executed) control logic 310. Module 300 includes memory 330 and/or access to memory resource 330 for storing data and/or instructions. Module 300 also includes one or more interfaces 340, which represent access interfaces to/from module 300 with regard to entities (electronic or human) external to module 300. Interfaces 340 allow interface software to interact with module 300, and may provide input/output functions, displays, etc.

Module 300 also includes radio interface engine 350, which represents one or more functions that enable module 300 to provide multi-radio interface. The functions include one or more of radio detection feature 352, configuration information gathering feature 354, channel list creation feature 356, load balancing feature 358, packet ordering feature 360, and radio configuration feature 362. Other features may be included, and some functions may not exist in certain implementations making other versions of radio interface engine 350 that are more or less complex than what is shown.

Radio detection feature 352 enables radio interface engine 350 to determine how many radios are present in a mesh point of which module 300 is a part. Radio detection feature 352 may include a list or setting in the mesh point, an interface fiction or software call that enables radio interface engine 350 to obtain the information from other programs/modules on a mesh point to indicate the number of radios. Radio detection feature 352 may include a program interface with a hardware driver to enable a detection of hardware settings regarding a number of radios. Radio detection feature 352 can generate a list of radio priorities to indicate an order of preference of radios in the mesh point.

Configuration information gathering feature 354 enables radio interface engine 350 to perform operations to obtain information related to an operating environment of the mesh point. Configuration information gathering feature 354 may include channel scanning, interference detection, assessment of radio operation, etc. Configuration information gathering feature 354 may include the ability for module 300 to initiate a configuration change parameter. In an implementation where the mesh point of which module 300 is a part becomes the leader node, configuration information gather feature 354 can include the ability to gather and process information from other mesh points and the determining of the proper configuration parameters for the mesh network.

Channel list creation feature 356 enables radio interface engine 350 to generate a channel list, for example, in the case where module 300 is part of a leader node. This information could be determined from information gathered from multiple or all mesh points of the mesh network. The resulting channel list indicates a priority order of channels, which can be used by the mesh points to configure their radios.

Load balancing feature 358 enables radio interface engine 350 to distribute packets across multiple radios to reduce the traffic load on any particular radio, and share the traffic load across the radios in a mesh point. Load balancing feature 358 may be inactive in a mesh point with only a single radio. Load balancing feature 358 may include the functions for determining a load profile, determining a packet path, deciding which neighbor(s) to use for a particular packet or message, etc., such as described above with respect to FIG. 2.

Packet ordering feature 360 enables radio interface engine 350 to reorder packets received out of order for forwarding to upper layers and/or a next hop in a transmit path. Packet reordering feature may include a timer, a counter, and/or other mechanism for placing thresholds on how long a packet will stay in a queue. For example, if a threshold is reached, the packet may be forwarded regardless of order.

Radio configuration feature 362 enables radio interface engine 350 to configure or cause the configuration of radios according to information received in a channel list. Thus, radios may be assigned channels or other configuration based on a priority order of channels and/or radios.

Module 300 may include hardware, software, and/or a combination of these. In a case where module 300 includes software, the software data, instructions, and/or configuration may be provided via an article of manufacture by a machine/electronic device/hardware. An article of manufacture may include a machine accessible/readable medium having content to provide instructions, data, etc. The content may result in an electronic device, for example, a filer, a disk, or a disk controller as described herein, performing various operations or executions described. A machine accessible medium includes any mechanism that provides (i.e., stores and/or transmits) information/content in a form accessible by a machine (e.g., computing device, electronic device, electronic system/subsystem, etc.). For example, a machine accessible medium includes recordable/non-recordable media (e.g., read only memory (ROM), random access memory (RAM), magnetic disk storage media, optical storage media, flash memory devices, etc.), as well as electrical, optical, acoustical or other form of propagated signals (e.g., carrier waves, infrared signals, digital signals, etc.), etc. The machine accessible medium may further include an electronic device having code loaded on a storage that may be executed when the electronic device is in operation. Thus, delivering an electronic device with such code may be understood as providing the article of manufacture with such content described above. Furthermore, storing code on a database or other memory location and offering the code for download over a communication medium via a propagated signal may be understood as providing the article of manufacture with such content described above.

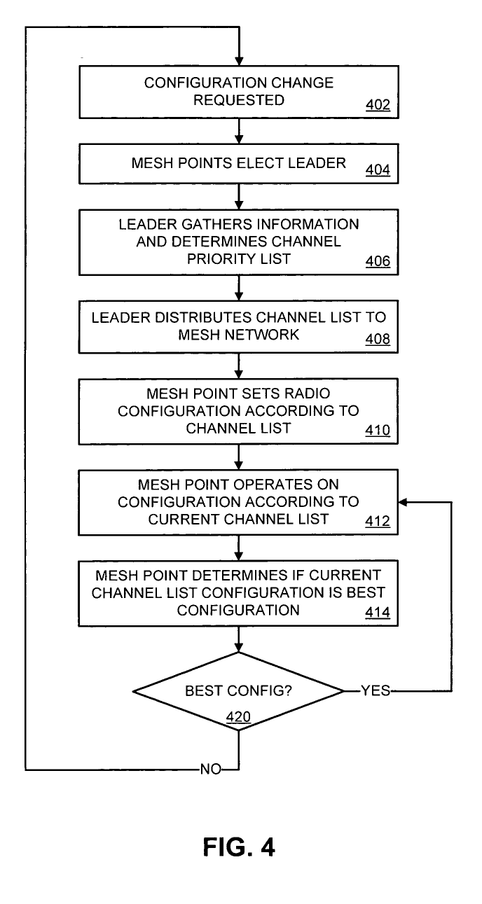

FIG. 4 is a flow diagram of an embodiment of assigning channels to radios in a mesh network. A mesh point may determine that a current configuration is not an optimum configuration, meaning that a different configuration could allow better throughput for the particular mesh point. The mesh point that determines the current configuration is not ideal in this sense can request a configuration change, 402. When a configuration change is requested, if the mesh network operates under the leader node election mentioned above, the mesh points will elect a leader, 404. The leader may be the mesh point that requested the configuration change, or in the case of multiple mesh points requesting a change, the leader will be elected through some collision mechanism (e.g., mesh point with the lowest MAC address).

When the mesh points in the network know which mesh point is the leader, they send information regarding interference, parameter settings, etc., to the leader. The leader thus gathers configuration information and determines a channel priority list, based on the information gathered from the network, 406. The determination of a channel list may account for the interference environment across the entire network. The channel list, if properly compiled, can allow for higher throughput across the network than another priority order of channels. However, the particular details of channel list determination are outside the scope of the present discussion, except inasmuch as channel list determination relates to the distribution and configuring of the mesh network based on the channel list determination.

The leader that generates the channel list distributes the channel list to the mesh network, 408. In response to receiving the channel list, the mesh points configure their radio settings according to the channel list, 410. The mesh points configuring their radios includes assigning channels to the radios in accordance with information obtained from the channel list. If a mesh point includes more than one radio, each radio can be assigned its channel based on the priority of the radio. A radio of first priority takes the highest preference channel of the channel list, and so forth. In some cases this will not require a change (e.g., the priority order designated for a particular channel may be the same in the received channel list as the previous channel list that resulted in the current configuration). For example, in a start-up or initialization sequence, the mesh point may discover the channel of corresponding priority with one of its radios, and obtain the channel list to set the other channels. Also, for mesh points already configured and operating on the mesh network, a channel's priority may not change with the updated channel list. If the channel list reassigns particular channels, the channels available to send traffic to a particular destination may be different, requiring the use of a different transmit path. The reassignment of channels, meaning the association of channels with other radios may also cause a realignment of one or more queues.

After changing the configuration as outlined in the channel list, the mesh point operates according to the configuration of the current channel list received, 412, which may be referred to as normal operation. Under normal operation, a mesh point may continue to monitor the settings and resources it has. The mesh point can use the information gathered during monitoring the resources to determine if the current channel list configuration is the best configuration, 414. The best configuration refers to a configuration that provides for higher throughput than other configurations. If the configuration is the best configuration, 420, the mesh point continues under normal operation. If the configuration is not the best configuration, the mesh point may request a configuration change, 402.

In one embodiment determining whether the current configuration is the best configuration includes determining whether a configuration change request has been made for the particular parameter within a threshold amount of time. If one has been made, the mesh point may hold off until the threshold time has past before making the request. In this way the possibility of endless recursive change requests are reduced. Alternatively, a schedule of possible change request periods may be established for the network, and the mesh points are allowed at only particular times to request changes.

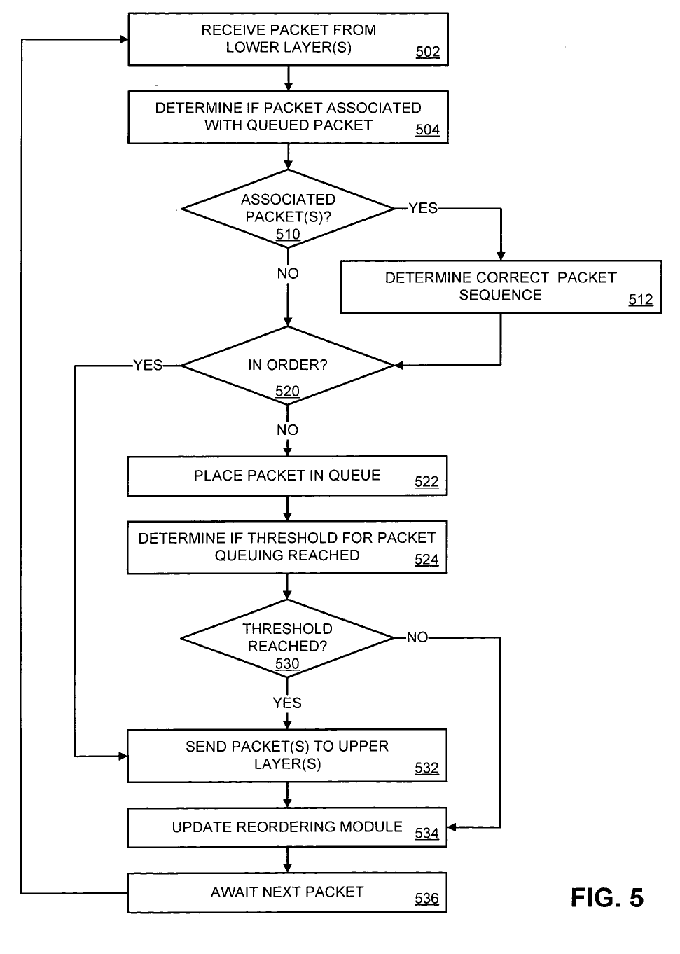

FIG. 5 is a flow diagram of an embodiment of receiving a packet at a mesh point having multiple radios. A radio interface module receives packets from a lower layer, 502. The lower layer may be the hardware with which the module interacts, or a layer of software lower than the module. The module described with reference to this implementation includes one or more features to enable packet reordering. The module determines if the received packet is associated with another packet currently in a receive queue, 504. If the received packet has one or more associated packets that are queued, 510, the module determines the correct packet sequence of the received packet and the queued packet(s), 512. The module determines if the received packet, and potentially other associated queued packets, is in correct order, 520. The received packet may be received in order. Also, the received packet may be a missing prior packet as regarding a queued packet, meaning the queued packet would be in order after the received packet. If the packet or packets are in order, the packets can be sent to an upper layer, 532. If the packet(s) are not in order, the received packet is placed in the queue, 522. If the received packet is associated with other packets, the received packet may be queued in order with the already queued packet(s).

In placing a packet in the queue, the module may trigger a counter or a timer for a packet or a group of related packets to prevent the packet from sitting for an indeterminate period of time in the queue. A counter could count a number of received packets, a number of packets placed in the queue, or a number of associated packets. Upon reaching or exceeding a threshold number on the counter, the module may determine to send the packet(s) corresponding to the counter to an upper layer out of order. A timer would work similarly, and be set for a packet or a group of packets. In one embodiment a timer is set for a group of packets and the timer could be reset for each time an associated packet is queued with the group. Similarly to the counter, if the threshold is reached, the packet(s) may be sent to the upper layer out of order, meaning out of correct message sequence. Thus, if the threshold is reached or exceeded, 530, the packet(s) could be sent to an upper layer, 532.

Sending a packet to the upper layer may require updating information regarding a packet or a message in the module. In one specific example, sending a packet, especially if a queued packet is already sent, or if the received packet is queued, the reordering module may be updated, 534, to allow the reordering module to track packets associated with a message. If a threshold is not reached, 530, the reordering module may also be updated, 534. The reordering module may then await the next packet to be received by a radio on the mesh point, 536.

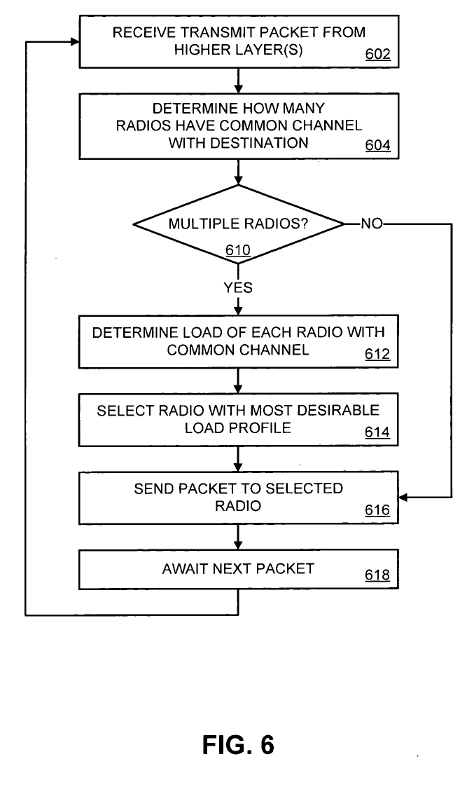

FIG. 6 is a flow diagram of an embodiment of load balancing transmit traffic across multiple radio resources in a mesh point. A load balancing module receives a packet from a higher layer, 602. The module determines how many radios have a common channel with the destination, or with a next hop in a path toward to the destination, 604. The mesh topology and radio links may be known prior to packet receipt. If there are not multiple radios available, the single radio available will be used, and the module may send the packet on that resource, 616. If there are multiple radios, the module may determine a load profile for each available channel, 612. Determining the load has been discussed previously, and in one implementation includes determining a queue depth associated with each radio. The module will generally select the radio with the most desirable load profile, 614, and will send the packet to that radio for transmission, 616. Sending the packet to the radio can refer to placing the packet in a transmit queue. The module awaits the next packet, 618, for transmission.

Besides what is described herein, various modifications may be made to the disclosed embodiments and implementations of the invention without departing from their scope. Therefore, the illustrations and examples herein should be construed in an illustrative, and not a restrictive sense. The scope of the invention should be measured solely by reference to the claims that follow.

What is claimed is:

1. A method comprising:
receiving at a mesh point of a wireless mesh network a channel priority list indicating a priority order of multiple wireless channels of the wireless mesh network; and
configuring one or more wireless communication resources based at least in part on the channel priority list, including assigning each wireless communication resource to a wireless channel of a priority corresponding to a priority of the wireless communication resource.

2. A method according to claim 1, further comprising:
identifying a wireless communication resource of the one or more wireless communication resources with a particular outgoing traffic load profile; and
sending an outgoing transmit packet to the identified wireless communication resource for transmit.

3. A method according to claim 2, wherein identifying the wireless communication resource with the particular outgoing traffic load profile comprises identifying the wireless communication resource having a least full transmit queue.

4. A method according to claim 2, wherein identifying the wireless communication resource with the particular outgoing traffic load profile is performed in response to configuring the wireless communication resources based at least in part on the channel priority list.

5. A method according to claim 1, further comprising:
for a receive packet, determining if the receive packet is received in sequential order of an associated message; and
sending the receive packet up to a higher protocol layer if the receive packet is received in order, or else queuing the packet in a receive queue.

6. A method according to claim 5, further comprising:
if the receive packet is in the receive queue, determining if a threshold amount of time has elapsed since the receive packet was placed in the receive queue; and
if the threshold amount of time has elapsed, sending the receive packet to the higher protocol layer out of order.

7. A method comprising:
generating a channel priority list to indicate a priority order of multiple wireless channels of a wireless mesh network with multiple mesh points; and
transmitting the channel priority list to a mesh point having one or more radios, the radios having a priority order, to cause the mesh point to assign each of the radios to a channel of corresponding priority.

8. A method according to claim 7, wherein generating the channel priority list further comprises:
selecting a leader from among the mesh points to act as a master to generate and distribute the channel priority list.

9. A method according to claim 7, wherein the mesh point comprises a wireless access point.

10. A method according to claim 7, wherein the one or more radios comprise radio frequency communication devices on multiple, separate wireless network interface cards.

11. An article of manufacture comprising a machine accessible medium having content to provide instructions which when executed cause a machine to perform operations including:
receiving a channel list indicating an order of preference of multiple wireless channels of a wireless mesh network, the order of preference including the wireless channels of the wireless mesh network in order from a most preferred to a least preferred of the wireless channels;
assigning a wireless channel to each of multiple radios in accordance with the channel list, the radios being assigned wireless channels of corresponding preference; and
distributing packets of transmit traffic across the multiple radios to load balance the transmit traffic.

12. An article of manufacture according to claim 11, wherein distributing the packets across the multiple radios comprises sending packets to radios based at least in part on a depth of a transmit queue associated with each radio.

13. An article of manufacture according to claim 11, further comprising the content to provide instructions to cause the machine to perform operations including:
for a receive packet, determining if the receive packet is received in order; and
sending the receive packet to an upper layer if the receive packet is received in order, or else queuing the packet in a receive queue.

14. An article of manufacture according to claim 11, further comprising the content to provide instructions to cause the machine to perform operations including:
generating the channel list from information received from other mesh points, including information relating to an interference environment of the wireless channels of the wireless mesh network.

15. An apparatus comprising:
a wireless network interface to receive a channel list indicating a determined priority for channels of a wireless mesh network, the wireless network interface having a priority; and
a radio interface module coupled to the wireless network interface to configure the wireless network interface to assign a channel of the channel list to the wireless network interface, the channel having a priority corresponding to the priority of the wireless network interface.

16. An apparatus according to claim 15, wherein the radio interface module comprises a radio interface module implemented in software.

17. An apparatus according to claim 15, the radio interface module to further distribute packets of a single message across multiple wireless network interfaces to perform load balancing of outbound traffic among the wireless network interfaces.

18. An apparatus according to claim 17, the radio interface module to further re-order inbound traffic packets to perform packet sequence correction on packets received out of order.

19. A system comprising:
multiple wireless network interfaces within a node of a wireless mesh network to exchange traffic in the wireless mesh network, the network interfaces having an order of priority, one of the wireless network interfaces to receive a channel list indicating an order of priority for channels of the wireless mesh network;
an omnidirectional antenna coupled to the wireless network interfaces to transmit and receive radio signals formatted according to a format compliant with an IEEE 802.11 standard, through which the network interfaces are coupled to the wireless mesh network; and
a radio interface module coupled to the wireless network interfaces to assign channels of corresponding priority to each of the wireless network interfaces, according to the received channel list.

20. A system according to claim 19, the radio interface module to further distribute packets of a single message across multiple wireless network interfaces to perform load balancing of outbound traffic among the wireless network interfaces.

21. A system according to claim 19, the radio interface module to further re-order inbound traffic packets to perform packet sequence correction on packets received out of order.
